(19) United States
(12) Patent Application Publication
(10) Pub. No.: US 2026/0046343 A1
(43) Pub. Date: Feb. 12, 2026

(54) TECHNIQUES FOR UNIFYING CLOUD INFRASTRUCTURE MANAGEMENT

(71) Applicant: Microsoft Technology Licensing, LLC, Redmond, WA (US)

(72) Inventors: Siri Teja Reddy KASIREDDY, Ranga Reddy (IN); Aditya KANETKAR, Nagput (IN); Krupesh S. DHRUVA, Hyderabad (IN); Akash KESHARI, Bhopal (IN)

(21) Appl. No.: 18/798,608

(22) Filed: Aug. 8, 2024

(51) Int. Cl. H04L 67/563; H04L 61/59; H04L 67/289; H04L 67/60

(52) U.S. Cl. CPC H04L 67/563; H04L 61/59; H04L 67/289; H04L 67/60

(57) ABSTRACT

Described are examples for providing access to an on-premises resource executing via a cloud-computing environment. A client-side proxy executing on a centralized node in the cloud-computing environment can receive, from a client resource provider (RP) that communicates with the client-side proxy via a client RP virtual network established in the cloud-computing environment, a request by a requesting node to access the on-premises resource. The client-side proxy can provide, based on the request, access to the on-premises resource for the requesting node.

### BACKGROUND

Cloud service providers are providing cloud-computing environments for distributed storage and access of software (e.g., services or other applications), files, data, etc. across multiple devices connected via a network, such as the Internet. Using distributed nodes to store data and/or allow execution of the software can improve reliability of the software and data through redundancy, improved on-demand access of the software and data from various other nodes in the network, more efficient execution of software or retrieval of data by using certain nodes or services in the network, and/or the like. A cloud-computing environment can include one or more compute clusters that provide one or more functions. The compute clusters can include a workload that executes on one or more nodes to provide redundant functionality, and a load balancer or router that can balance requests across workloads or route requests based on a characteristic (e.g., an identifier in the request that is associated with one of the workloads).

Cloud service providers often face challenges in managing and accessing shared infrastructure components across different resource providers. The resource providers can include client resource providers that share a resource over the cloud-computing environment provided by the cloud service provider, enabling the cloud service provider to offer access to the on-premises resource. One such infrastructure component can include a client-side proxy (CSP), which each on-premises resource provider executes to facilitate access to the on-premises resource by the cloud-computing environment. Manual configuration changes, network complexities, and lack of automated failover mechanisms associated with the shared infrastructure components can lead to operational inefficiencies and downtime during regional disasters.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a device for providing access to an on-premises resource executing via a cloud-computing environment is provided. The device includes one or more memories storing instructions, and one or more processors coupled to the one or more memories. The one or more processors are configured to execute the instructions to receive, by a client-side proxy executing on a centralized node in the cloud-computing environment and from a client resource provider (RP) that communicates with the client-side proxy via a client RP virtual network established in the cloud-computing environment, a request by a requesting node to access the on-premises resource, and provide, by the client-side proxy and based on the request, access to the on-premises resource for the requesting node.

In another example, a device for providing access to an on-premises resource executing via a cloud-computing environment is provided. The device includes one or more memories storing instructions, and one or more processors coupled to the one or more memories. The one or more processors are configured to execute the instructions to receive, for a client-side proxy executing on a centralized node in a cloud-computing environment, and via a client RP virtual network established in the cloud-computing environment, a request by a requesting node to access the on-premises resource, and provide, to the client-side proxy, the request from the requesting node to facilitate access to the on-premises resource for the requesting node.

In another example, a computer-implemented method for providing access to an on-premises resource executing via a cloud-computing environment is provided. The method includes receiving, by a client-side proxy executing on a centralized node in the cloud-computing environment and from a client RP that communicates with the client-side proxy via a client RP virtual network established in the cloud-computing environment, a request by a requesting node to access the on-premises resource, and providing, by the client-side proxy and based on the request, access to the on-premises resource for the requesting node.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a system having a centralized client-side proxy (CSP) in a cloud-computing environment, in accordance with aspects described herein.

FIG. 2 is a flow diagram of an example of a method for operating a CSP instance on a CSP node centralized in a cloud-computing environment, in accordance with aspects described herein.

FIG. 3 is a flow diagram of an example of a method for communicating with a CSP instance on a CSP node centralized in a cloud-computing environment, in accordance with aspects described herein.

FIG. 4 illustrates an example of a system for providing a centralized CSP using virtual networks, in accordance with aspects described herein.

FIG. 5 illustrates an example of clusters in a cloud-computing environment each having one or more CSP instances, in accordance with aspects described herein.

FIG. 6 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to a unified approach to streamline infrastructure management, ensure continuous availability, and improve disaster recovery capabilities in cloud-computing environments. In an example, some cloud infrastructure components can be centralized to a node in the cloud-computing environment to facilitate centralized management thereof, which can achieve the benefits of ensuring continuous availability and improving disaster recovery. For example, one or more centralized nodes in the cloud-computing environment can host the client-side proxy (CSP) process for accessing by client resource providers (RPs), which may be associated with different virtual networks in the cloud-computing environment. In this regard, for example, a client RP can access the CSP using a hostname or address provided by the cloud-computing environment, and the cloud-computing environment can handle mapping of the hostname or address to a load balancer, ingress controller, or other node that can provide access to the CSP instance. In addition, in this regard for example, the cloud-computing environment can resolve the hostname or address of the used for the CSP instance to different nodes to handle disaster recovery.

In one example, the client RP can peer, or request peering of, a virtual network in the cloud-computing environment that is associated with the client RP (referred to herein as a client RP virtual network) with a virtual network associated with the CSP (referred to herein as a CSP virtual network). This can facilitate access between the client RP (or corresponding network or nodes) and the CSP via the virtual networks hosted by the cloud-computing environment. In an example, domain name service (DNS) zones can be configured in the client RP virtual network to resolve the CSP, which can allow for disaster recovery by updating the DNS zones.

In another example, the cloud-computing environment can expose the CSP as a public node, which may include exposing a load balancer or ingress controller that manages the CSP or one or more CSP instances. In this example, the client RP (or corresponding network or nodes) can access the CSP as a public node. In this example, DNS zones can be managed to resolve the publicly available CSP, and DNS records can be dynamically updated to redirect traffic in disaster recovery.

For example, by providing a centralized CSP in this regard, a unified and streamlined approach to cloud infrastructure management and disaster recovery across multiple RPs can be achieved. For example, by effectively configuring virtual networks and DNS zones, seamless access to CSP infrastructure hosted within one RP can be enabled from another RP, while ensuring security, scalability, and high availability. Aspects described herein can provide a unified solution for managing cloud infrastructure components across different RPs, reducing duplication of efforts and operational complexities. Using an automated deployment processes and dynamic load balancing mechanisms, for example, aspects described herein can enhance disaster recovery capabilities by facilitating failover procedures and ensuring continuous availability during regional disasters. By leveraging dynamic load balancing and traffic routing techniques, aspects described herein can optimize resource utilization and scalability, enabling efficient handling of varying workloads and traffic patterns. Through the use of virtual network peering, Network Security Groups (NSGs), and secure access control mechanisms, aspects described herein can maintain network isolation and enforce strict security policies to protect against unauthorized access and external threats. Automated deployment processes and dynamic DNS record updates can streamline infrastructure management tasks and eliminate the need for manual intervention during disaster recovery events, enhancing operational efficiency and reducing downtime.

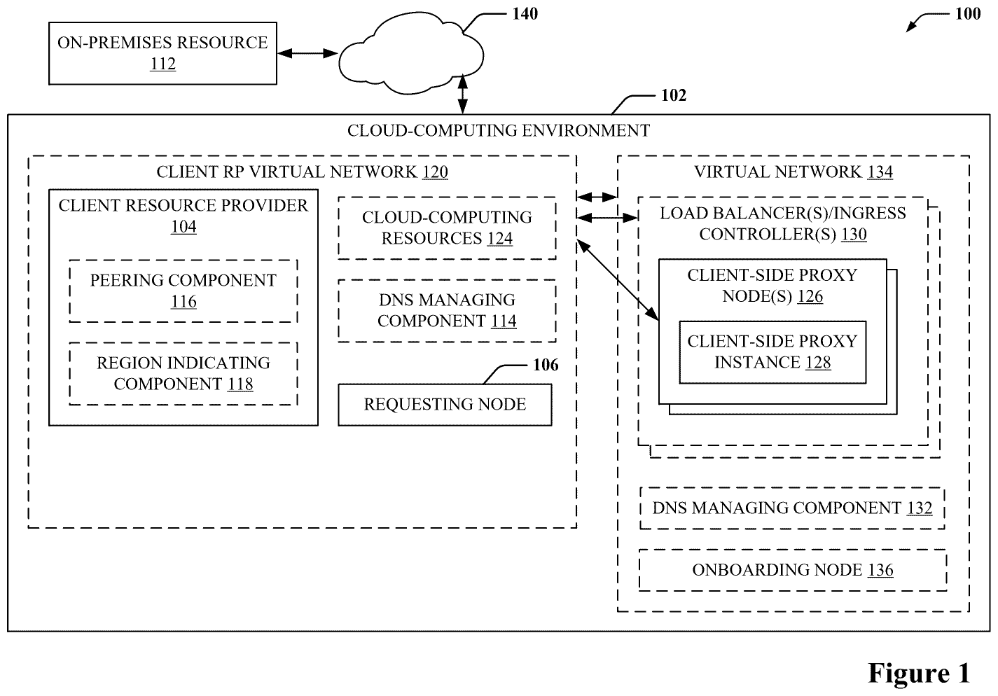

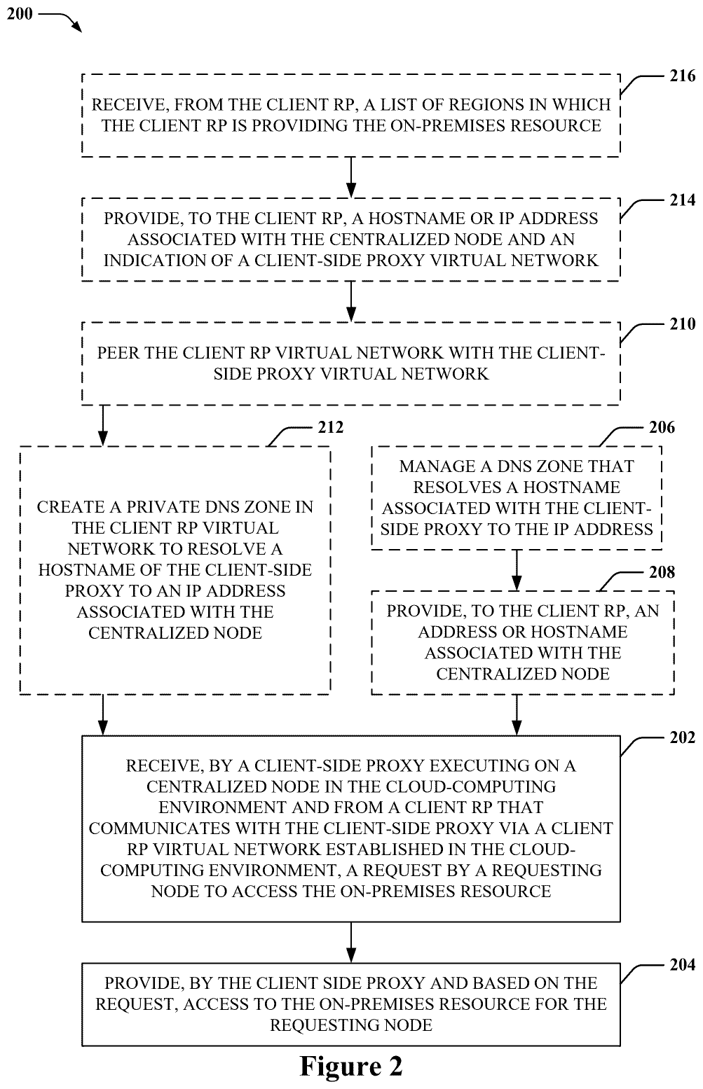

Turning now to FIGS. 1-6, examples are depicted with reference to one or more components and one or more methods that may perform the actions or operations described herein, where components and/or actions/operations in dashed line may be optional. Although the operations described below in FIGS. 2-4 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

FIG. 1 is a schematic diagram of an example of a system 100 having a centralized CSP in a cloud-computing environment, in accordance with aspects described herein. System 100 includes a cloud-computing environment 102, which can include distributed nodes that store data and/or allow execution of software applications, services, or processes. The cloud-computing environment 102 can include one or more compute clusters that provide one or more functions and may include a workload that executes on one or more nodes to provide redundant functionality, and a load balancer or router that can balance requests across workloads or route requests based on a characteristic, an ingress controller to direct incoming traffic to certain nodes, etc. Cloud-computing environment 102 can also include a client RP 104, which can communicate in the cloud-computing environment 102 for accessing an on-premises resource 112. For example, the client RP 104 can be substantially any service hosted in cloud-computing environment 102 that can connect to the on-premises resource 112 via a CSP.

In an example, the client RP 104 can be hosted in a client RP virtual network 120, which can be established for the client RP 104 for performing function within the cloud-computing environment 102 or otherwise communicating with nodes in the cloud-computing environment 102, and/or on-premises node 112 via cloud-computing environment 102. For example, the on-premises resource 112 can include a software application and/or data source which the client RP 104 can access by using the cloud-computing environment 102. In addition, the client RP 104, or another node in the client RP virtual network 120, can optionally include a peering component 116 to establish, or request establishment of, peering between the client RP virtual network 120 and the CSP virtual network, and/or a region indicating component 118 to indicate one or more regions to which the client RP 104 or associated on-premises resource 112 is to be supported and/or deployed.

In an example, the cloud-computing environment 102 can establish one or more virtual networks, such as the client RP virtual network 120 and virtual network 134. For example, cloud-computing environment 102 can establish client RP virtual network 120 based on a request from a node associated with the client RP. For example, an administrator associated with the client RP or an associated client can request the cloud-computing environment 102 to establish the client RP virtual network 120, which the administrator or client can then use to access the on-premises resource 112, associated configurations, request establishment of certain network configurations for the client RP virtual network 120, request access to certain cloud-computing resources 124 (e.g., for the client RP 104 or other purposes), etc. In an example, client RP virtual network 120 can optionally include cloud computing resources 124, which can include resources of the cloud-computing environment 102, such as one or more nodes, applications, data sources, virtual machines (VMs), load balancers, or other nodes that can be provided in the client RP virtual network 120 established for the client RP by the cloud-computing environment 102, and/or a DNS managing component 114 for managing one or more DNS zones in the client RP virtual network 120 to resolve to a CSP virtual network.

In an example, the cloud-computing environment 102 can also include one or more CSP nodes 126 that each host a CSP instance 128. In this regard, as described, the CSP instance 128 can be centralized or unified in the cloud-computing environment 102, rather than deployed locally at each client RP, which can facilitate centralized management of the CSP instance 128, failure recovery for the CSP instance 128, etc. In one example, cloud-computing environment 102 can expose the CSP node(s) 126 as having a publicly-available domain, internet protocol (IP) address, etc., such that the CSP node(s) 126 are reachable via the Internet and/or network 140 using the publicly-available domain name, IP address, etc. In one example, the CSP node(s) 126 can be behind (or associated with) load balancer(s) and/or ingress controller(s) 130, and the publicly-available domain name, IP address, etc. can resolve to the load balancer(s) and/or ingress controller(s) 130, or other traffic-management nodes, which can forward data to and/or from the CSP node(s) 126 based on one or more algorithms (e.g., load balancing algorithms, forwarding algorithms, etc.). In an example, cloud-computing environment 102 can include a DNS managing component 132 for managing a DNS zone to resolve the publicly-available domain name, IP address, etc. to the CSP node(s) 126 or the load balancer(s) and/or ingress controller(s) 130.

In another example, the cloud-computing environment 102 can include virtual network 134 as a CSP virtual network that can include the CSP node(s) 126 and/or can include one or more load balancer(s) and/or ingress controller(s) 130. In this example, the CSP node(s) 126 can be in a private virtual network, and the client RP 104 can request peering of the client RP virtual network 120 with the CSP virtual network 134 to allow the client RP 104 to access the CSP node(s) 126 and/or associated CSP instances 128. In addition, in an example, cloud-computing environment 102 can include an onboarding node 136 that can facilitate setting up the client RP 104 to communicate with the CSP node(s) 126 or associated CSP instances 128 by providing domain name or IP address information for the CSP node(s) 126, virtual network information for the CSP node(s) 126, etc., as described herein.

In one example, the client RP 104 can request establishment of client RP virtual network 120 for accessing the on-premises resource 112 via cloud-computing environment 102. In an example, the client RP 104 can request access to one or more CSP instances 128 from onboarding node 136, which can include indicating one or more regions to which the client RP 104 or on-premises resource 112 is to be provided. Onboarding node 136 can provide, to the client RP 104, information regarding the CSP instance(s) 128 at one or more regions, which may include a domain name or IP address of the CSP node(s) 126 hosting the CSP instance(s) 128 (or of load balancer(s) or ingress controller(s) 130 associated with the CSP node(s) 126), virtual network information of a virtual network associated with the CSP node(s) 126, and/or the like. In this example, peering component 116 can request peering of the client RP virtual network 120 with the CSP virtual network 134 and/or DNS managing component 114 can create or manage one or more private DNS zones to resolve names of the CSP instance(s) 128 to the domain name or IP addresses associated with the CSP node(s) 126 hosting the CSP instance(s) 128 (or of load balancer(s) or ingress controller(s) 130 associated with the CSP node(s) 126).

In this example, the client RP 104 can access the CSP instance 128 based on peering between the virtual networks 120 and 134. For example, client RP 104 can include code that communicates with the CSP instance 128 using a hostname, which the DNS managing component 114 can resolve to the CSP instance 128 based on the hostname mapping to an address of the CSP node 126 (or load balancer or ingress controller 130) corresponding to the CSP instance 128 that is in the virtual network 134 that is accessible by the client RP virtual network 120 based on the virtual network peering. In another example, the client RP 104 can access the CSP node 126 based on a hostname that maps to a publicly-available domain name or IP address of the CSP node 126 (or load balancer or ingress controller 130), as described above. In any case, the CSP instance can be centralized or unified in the cloud-computing environment 102 in this regard, to facilitate centralized management thereof, failure recovery where the hostname can be modified (e.g., in DNS zones) to point to a different IP address, etc.

In an example, client RP 104 can utilize the requesting node 106 to request access to the on-premises resource 112 using CSP instance 128. In any case, CSP instance 128 can obtain the request, and can communicate with the on-premises resource 112 on behalf of the client RP 104. This can allow the cloud-computing environment 102 to control aspects of providing access to the on-premises resource 112, such as access control, communication between the on-premises resource 112 and clientRP 104 or other other cloud-computing resources 124 (such as other applications, data stores, etc.), and/or the like.

FIG. 2 is a flowchart of an example of a method 200 for operating a CSP instance on a CSP node centralized in a cloud-computing environment, in accordance with aspects described herein. For example, method 200 can be performed by a cloud-computing environment 102, and/or one or more nodes or components thereof, to facilitate communicating with or managing the CSP instance, as described herein.

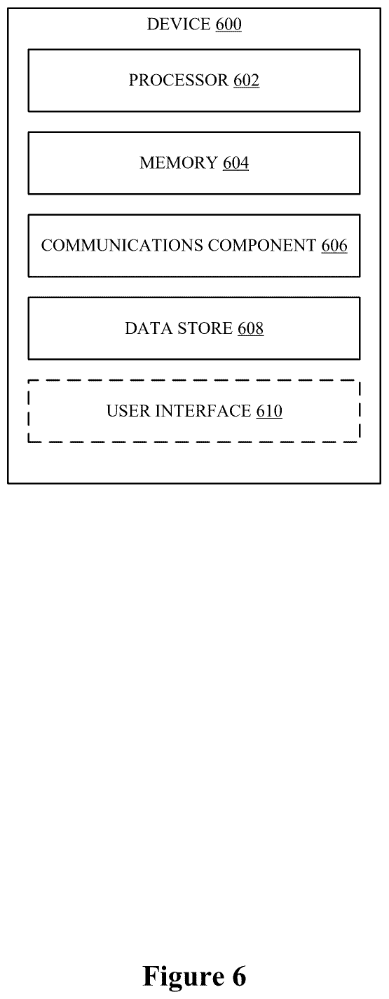

In method 200, at action 202, a request can be received, by a CSP executing on a centralized node in a cloud-computing environment and from a client RP that communicates with the CSP via a client RP virtual network established in the cloud computing-environment, where the request is by a requesting node to access the on-premises resource. In an example, CSP instance 128, e.g., in conjunction with CSP node 126 or one or more processor(s), memory/memories, etc. of the CSP node 126, can receive, from the client RP (e.g., client RP 104) that communicates with the CSP via the client RP virtual network (e.g., on-premises RP virtual network 120) established in the cloud-computing environment (e.g., cloud-computing environment 102), the request by the requesting node (e.g., requesting node 106) to access the on-premises resource (e.g., on-premises resource 112). In an example, the client RP 104 can include one or more processors for executing or otherwise providing functionality of the client RP 104, as described herein, and/or one or more memories to store instructions or other data to facilitate executing or otherwise providing functionality of the client RP 104 via the one or more processors (e.g., as described in further detail for device 600 in FIG. 6). Thus, in one example, the client RP 104 can be or can include device 600 in FIG. 6. In addition, for example, the CSP node 126 can include one or more processors for executing or otherwise providing functionality of the CSP instance 128, as described herein, and/or one or more memories to store instructions or other data to facilitate executing or otherwise providing functionality of the CSP instance 128 via the one or more processors (e.g., as described in further detail for device 600 in FIG. 6). Thus, in one example, the CSP node 126 can be or can include device 600 in FIG. 6.

In an example, the CSP instance 128 can receive the request directly from the client RP 104 (e.g., or at least via client RP virtual network 120) using a publicly-available domain name or address to access the CSP instance 128 (e.g., via load balancer/ingress controller 130 or otherwise), as described. In another example, the CSP instance 128 can receive the request from the client RP 104 through virtual network peering between the client RP virtual network 120 and the CSP virtual network 134, where the CSP node 126 is within a CSP virtual network 134. In any case, the CSP instance 128 can be centralized, in this regard, in the cloud-computing environment 102.

In method 200, at action 204, access to the on-premises resource for the requesting node can be provided by the CSP based on the request. In an example, CSP instance 128, e.g., in conjunction with CSP node 126 or one or more processor(s), memory/memories, etc. of the CSP node 126, can provide, based on the request, access to the on-premises resource (e.g., on-premises resource 112) for the requesting node (e.g., requesting node 106 and/or associated client RP 104 and/or more nodes or components thereof). For example, the CSP instance 128 can manage or facilitate access to the on-premises resource 112 via the cloud-computing environment 102 for one or more client devices, such as requesting node 106 and/or client RP 104. This may include managing authentication and/or authorization procedures for the one or more client devices to access the on-premises resource 112 and/or managing communications between the one or more client devices and the on-premises resource 112 via the cloud-computing environment 102 (e.g., via one or more virtual networks 120 and/or 134).

As described above, in one example, the CSP instance 128 can be publicly available through a domain name or IP address that resolves (e.g., on the Internet) to the associated CSP node 126 or load balancer/ingress controller 130. In this example, the CSP node 126 may or may not be part of a virtual network 134 in the cloud-computing environment 102. In method 200, optionally at action 206, a DNS zone that resolves a hostname associated with the CSP to the IP address (or domain name) can be managed. In an example, DNS managing component 132, e.g., in conjunction with an associated node in the cloud-computing environment 102, one or more processor(s) or memory/memories of such a node, etc., can manage the DNS zone that resolves the hostname associated with the CSP to the IP address (or domain name). For example, DNS managing component 132 can manage one or more public DNS zones that are publicly accessible via the Internet to resolve the hostname to IP address (or domain name) associated with the CSP instance 128, CSP node 126, load balancer/ingress controller 130 or other traffic manager that can distribute traffic across CSP instances hosted in different clusters in the cloud-computing environment 102, etc. In this regard, for example, DNS records can be dynamically updated to redirect traffic during disaster recovery events, which may mitigate a need for manual intervention.

In addition, in this example, in method 200, optionally at action 208, an address or hostname associated with the centralized node can be provided to the client RP. In an example, on-premises resource accessing component 122, e.g., in conjunction with an associated node in the cloud-computing environment 102, one or more processor(s) or memory/memories of such a node, etc., can provide, to the client RP, the address or hostname associated with the centralized node. For example, this can be the address or hostname that resolves to a domain name or IP address of the CSP node 126 or a traffic manager associated therewith (e.g., load balancer/ingress controller 130 associated therewith). In this regard, for example, the client RP 104 can use the address or hostname to access the publicly-available CSP instance 128 to request access to (or to provide the request from requesting node 106 for) the on-premises node 112 and/or to facilitate other communications between the client RP 104, or other nodes in the client RP virtual network 120, and the CSP instance 128.

In another example, as described, the CSP instance 128 can be deployed on a CSP node 126 in a CSP virtual network 134 established in the cloud-computing environment 102. In this example, in method 200, optionally at action 210, the client RP virtual network can be peered with the CSP virtual network. In an example, onboarding node 136, e.g., in conjunction with one or more processor(s) or memory/memories of such a node, etc., can peer the client RP virtual network (e.g., client RP virtual network 120) with the CSP virtual network (e.g., CSP virtual network 134), to facilitate communications between nodes of the virtual networks 120 and 134, such as between client RP 104, or nodes or components associated therewith, and CSP node 126 and/or associated CSP instance 128. In one example, onboarding node 136 can peer the virtual networks based on a request from the client RP 104.

In this example, in method 200, optionally at action 212, a private DNS zone can be created in the client RP virtual network to resolve a hostname of the CSP to an IP address associated with the centralized node. In an example, DNS managing component 114, e.g., in conjunction with an associated node in the cloud-computing environment 102, one or more processor(s) or memory/memories of such a node, etc., can create the private DNS zone in the client RP virtual network to resolve the hostname of the CSP to an IP address associated with the centralized node (e.g., associated CSP node 126). For example, the IP address can be an IP address of the CSP node 126 or of a load balancer/ingress controller 130 associated with the CSP node 126 and/or other CSP nodes 126 with CSP instances 128. In an example, DNS managing component 114 can create the private DNS zones based on peering the virtual networks so that requests from nodes associated with the client RP virtual network 120 (e.g., client RP 104 or requesting node 106 or associated nodes or components) that use the hostname can resolve to the CSP instance 128 via the CSP virtual network 134.

In method 200, optionally at action 214, a hostname or IP address associated with the centralized node and an indication of a CSP virtual network can be provided to the client RP. In an example, onboarding node 136, e.g., one or more processor(s) or memory/memories of such a node, etc., can provide, to the client RP (e.g., client RP 104), the hostname or IP address associated with the centralized node (e.g., CSP node 126) and the indication of the CSP virtual network 134. For example, onboarding node 136 can provide this information to the client RP 104 based on a request therefrom or an indication of one or more regions within which to provide access to the on-premises resource 112. Client RP 104 can use this information to perform or request virtual network peering, private DNS zone creation, etc., as described above.

In method 200, optionally at action 216, a list of regions on which the client RP is providing the on-premises resource can be received from the client RP. In an example, onboarding node 136, e.g., one or more processor(s) or memory/memories of such a node, etc., can receive, from the client RP (e.g., client RP 104), the list of regions in which the client RP is providing the on-premises resource 112. In this regard, for example, onboarding node 136 can select and provide, to the client RP, the hostname or IP address and associated virtual network information for the CSP instance(s) 128 associated with each region in the list of regions.

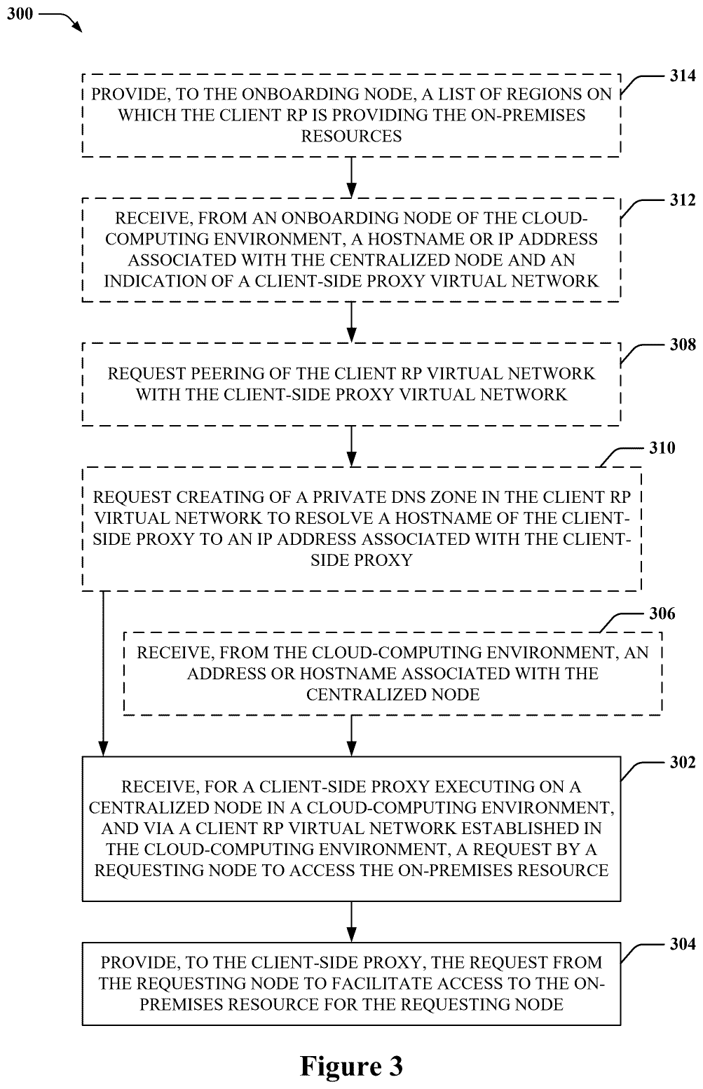

FIG. 3 is a flowchart of an example of a method 300 for communicating with a CSP instance on a CSP node centralized in a cloud-computing environment, in accordance with aspects described herein. For example, method 300 can be performed by a client RP 104, and/or one or more components or nodes thereof (e.g., requesting node 106), to facilitate communicating with the CSP instance via a cloud-computing environment 102, as described herein.

In method 300, at action 302, a request can be received, for a CSP executing on a centralized node in a cloud-computing environment, and via a client RP virtual network established in the cloud computing-environment, a request by a requesting node to access the on-premises resource. In an example, client RP 104, e.g., in conjunction one or more processor(s), memory/memories, etc. of the client RP 104, can receive, for the CSP (e.g., CSP instance 128) executing on the centralized node (e.g., CSP node 126) in a cloud-computing environment (e.g., cloud-computing environment 102), and via a client RP virtual network (e.g., client RP virtual network 120) established in the cloud-computing environment, the request by the requesting node (e.g., requesting node 106) to access the on-premises resource (e.g., on-premises resource 112). For example, as described, the client RP 104 can include one or more processors for executing or otherwise providing functionality described herein, and/or one or more memories to store instructions or other data to facilitate executing or otherwise providing functionality described herein via the one or more processors (e.g., as described in further detail for device 600 in FIG. 6). Thus, in one example, the client RP 104 or one or more nodes thereof (e.g., requesting node 106) can be or can include device 600 in FIG. 6.

In method 300, at action 304, the request from the requesting node can be provided to the CSP to facilitate access to the on-premises resource for the requesting node. In an example, client RP 104, e.g., in conjunction one or more processor(s), memory/memories, etc. of the client RP 104 or an associated node, can provide, to the CSP (e.g., CSP instance 128), the request from the requesting node (e.g., requesting node 106) to facilitate access to the on-premises resource (e.g., on-premises resource 112) for the requesting node. For example, as described, client RP 104 can provide the request to the CSP by using a publicly-available domain name or IP address associated with the CSP (e.g., a domain name or IP address of the CSP node 126 or of an associated load balancer/ingress controller 130). In another example, as described, client RP 104 can provide the request to the CSP using the client RP virtual network 120, which may be peered with the CSP virtual network 134. In addition, client RP 104 can otherwise communicate with the CSP instance 128 using the publicly-available domain name or IP address, or based on peered virtual networks, as described herein, for other purposes in providing the requesting node 106 with access to the on-premises resource 112.

For example, where the client RP 104 provides the request to the CSP instance 128 using a publicly-available domain name or IP address, the client RP 104 can be informed of a hostname that resolves the domain name or IP address in a public DNS zone. In method 300, optionally at action 306, an address or hostname associated with the centralized node can be received from the cloud-computing environment. In an example, client RP 104, e.g., in conjunction with one or more processor(s) or memory/memories of such a node, etc., can receive, from the cloud-computing environment 102, the address or hostname associated with the centralized node (e.g., CSP node 126). For example, the address or hostname can be an address or hostname that resolves to a domain name or IP address of the centralized node in a public DNS zone, or a domain name or IP address of a load balancer/ingress controller 130 associated with the centralized node. In this regard, as described, DNS managing component 132 can manage the public DNS zones to resolve the hostname to the appropriate domain name or IP address to handle failover in some scenarios.

In another example, where the client RP 104 provides the request to the CSP instance 128 using peered virtual networks, the client RP 104 can be informed of hostname or address information of the CSP instance 128 and virtual network information for peering. In this example, in method 300, optionally at action 308, peering of the client RP virtual network with the CSP virtual network can be requested. In an example, peering component 116, e.g., in conjunction with client RP 104, one or more processor(s) or memory/memories of client RP 104 or peering component 106, etc., can requesting peering of the client RP virtual network (e.g., client RP virtual network 120) with the CSP virtual network (e.g., CSP virtual network 134), to facilitate communications between nodes of the virtual networks 120 and 134, such as between client RP 104, or one or more nodes or components thereof or associated therewith, and CSP node 126 and/or associated CSP instance 128. In one example, peering component 116 can request peering of the virtual networks by providing such as request to a node in the cloud-computing environment 102, such as a node in virtual network 134 or otherwise.

In this example, in method 300, optionally at action 310, creation of a private DNS zone in the client RP virtual network can be requested to resolve a hostname of the CSP to an IP address associated with the centralized node. In an example, DNS managing component 114, e.g., in conjunction with one or more processor(s) or memory/memories of such a component or associated node, etc., can request creation of the private DNS zone in the client RP virtual network to resolve the hostname of the CSP to an IP address associated with the centralized node (e.g., associated CSP node 126). For example, the IP address can be an IP address of the CSP node 126 or of a load balancer/ingress controller 130 associated with the CSP node 126 and/or other CSP nodes 126 with CSP instances 128. In an example, DNS managing component 114 can create the private DNS zone in the on-premises RP virtual network 120, as described above.

In method 300, optionally at action 312, a hostname or IP address associated with the centralized node and an indication of a CSP virtual network can be received from an onboarding node of the cloud-computing environment. In an example, client RP 104, e.g., in conjunction with one or more processor(s) or memory/memories of such a node, etc., can receive, from the onboarding node (e.g., onboarding node 136) of the cloud-computing environment 102, the hostname or IP address associated with the centralized node (e.g., CSP node 126, or a load balancer/ingress controller 130 associated with the CSP node 126) and the indication of the CSP virtual network 134. As described, for example, client RP 104 can use this information to request peering of the virtual networks 120 and 134 and/or to request creation of the private DNS zones to resolve the hostname and/or IP address associated with the centralized node. In addition, for example, client RP 104 can receive this information based on a request send to the onboarding node 136, such as a request indicating one or more regions within which to provide access to the on-premises resource 112.

In method 300, optionally at action 314, a list of regions on which the client RP is providing the on-premises resource can be provided to the onboarding node. In an example, region indicating component 118, e.g., in conjunction with client RP 104, one or more processor(s) or memory/memories of on-premises RP 104 or region indicating component 118, etc., can provide, to the onboarding node 136, the list of regions in which the client RP 104 is providing the on-premises resource 112. In this regard, for example, onboarding node 136 can select and provide, to the client RP 104, the hostname or IP address and associated virtual network information for the CSP instance(s) 128 associated with each region in the list of regions.

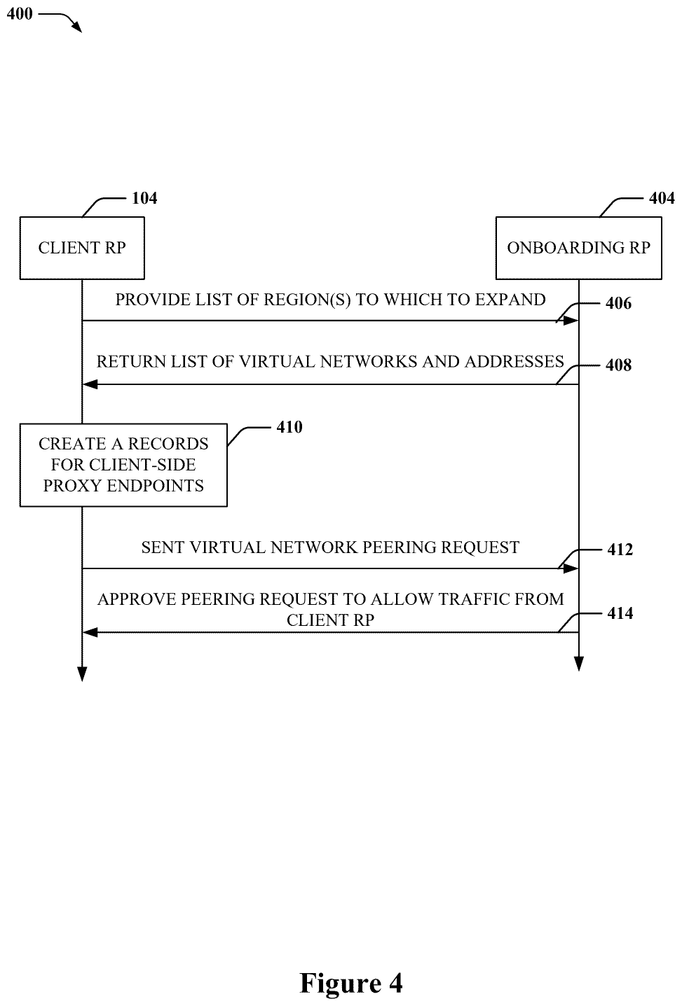

FIG. 4 illustrates an example of a system 400 for providing a centralized CSP using virtual networks, in accordance with aspects described herein. System 400 can include a client RP 104 and an onboarding RP 404. For example, onboarding RP 404 can include an onboarding node 136 and/or one or more other components of a cloud-computing environment 102 described herein. In an example, client RP 104 can provide access to a client resource (e.g., an on-premises resource) via the cloud-computing environment 102 and, at 406, can provide the onboarding RP 404 a list of regions to which to expand to provide access to the client resource. Onboarding RP 404 can determine one or more CSP instances related to each region in the list of regions, and can provide to the client RP 104, at 408, a list of virtual networks and addresses associated with the CSP instances (e.g., addresses of corresponding CSP nodes, of load balancers or ingress controllers, etc.).

At 410, the client RP 104 can create address (A) records for the CSP endpoints in a private DNS zone, which may be based on the list of addresses associated with the CSP instances. For example, client RP 104 can create A records that resolve a hostname each address. At 412, the client RP 104 can send a virtual network peering request to the onboarding RP 404 to peer a virtual network associated with the client RP 104 (e.g., an on-premises RP virtual network) with a virtual network associated with the CSP (e.g., a CSP virtual network). Onboarding RP 404 can, at 414, can approve the peering request to allow traffic from the client RP. In this regard, client RP 104 can access the CSP in the CSP virtual network using a hostname that resolves to the address of the CSP node (or load balancer or ingress controller) in the virtual network. In an example, during disaster recovery scenarios, manual intervention may be used by the onboarding RP 404 (or other node or component of the cloud-computing environment 102) to update DNS records or peer with alternative virtual networks to ensure uninterrupted access.

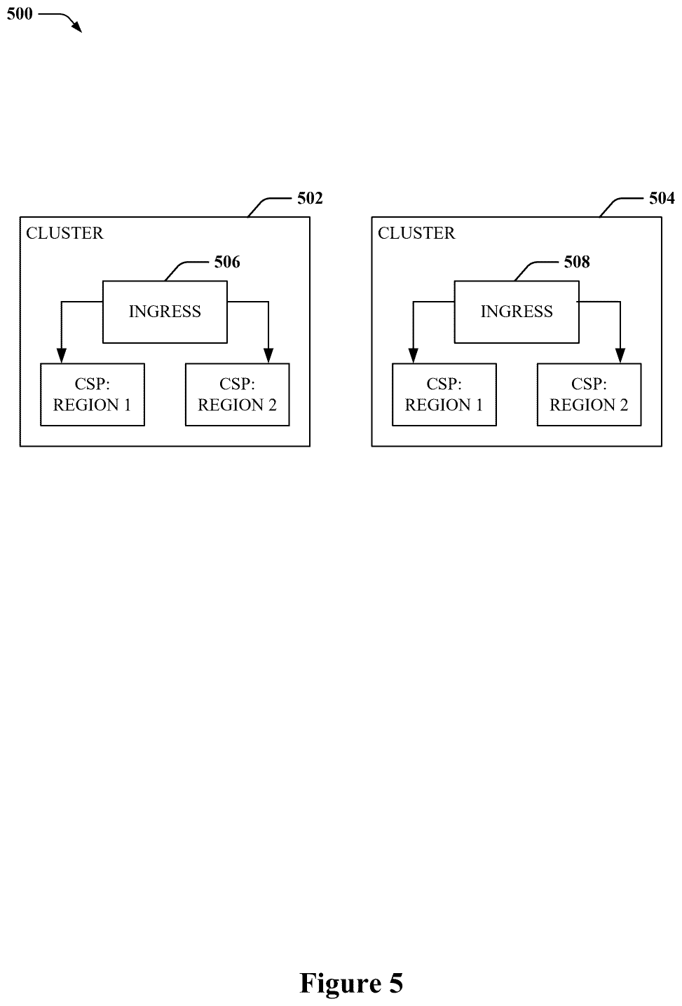

FIG. 5 illustrates an example of clusters 500 in a cloud-computing environment each having one or more CSP instances, in accordance with aspects described herein. For example, clusters 500 can include a first cluster 502 and a second cluster 504. The first cluster 502 can include an ingress controller 506 that routes traffic to multiple CSP instances (CSP: Region 1 and CSP: Region 2). Second cluster 504 can include an ingress controller 508 that routes traffic to multiple CSP instances (CSP: Region 1 and CSP: Region 2). In this regard, for example, CSP instances can be exposed via public load balancers/ingress controllers, such as ingress controllers 506 or 508, with publicly accessible IP addresses. A traffic manager can be used to distribute traffic across CSP instances hosted in different clusters 502 or 504. Public DNS zones can be created to resolve domain names to traffic manager endpoints (e.g., end points of public load balancers/ingress controllers, such as ingress controllers 506 or 508, as described). DNS records can be updated dynamically to redirect traffic during disaster recovery events, eliminating the need for manual intervention.

FIG. 6 illustrates an example of device 600 including additional optional component details as those shown in nodes, devices, or components in FIG. 1. In one aspect, device 600 may include processor 602 for carrying out processing functions associated with one or more of the nodes, devices, components, or functions described herein. Processor 602 can include a single or multiple set of processors or multi-core processors. Moreover, processor 602 can be implemented as an integrated processing system and/or a distributed processing system.

Device 600 may further include memory 604 for storing local versions of operating systems (or components thereof) and/or applications being executed by processor(s) 602, such as functions described in conjunction with the various nodes, devices, components, etc., in FIGS. 1-5. Memory 604 can include one or more memories, and each memory may be of a type of memory usable by a computer, such as random access memory (RAM), read only memory (ROM), tapes, magnetic discs, optical discs, volatile memory, non-volatile memory, and any combination thereof.

Further, device 600 may include a communications component 606 that provides for establishing and maintaining communications with one or more other nodes, devices, parties, entities, etc. utilizing hardware, software, and services as described herein. Communications component 606 may carry communications between components on device 600, as well as between device 600 and external devices, such as nodes, devices, etc. located across a communications network, as described herein, and/or devices serially or locally connected to device 600. For example, communications component 606 may include one or more buses, and may further include transmit chain components and receive chain components associated with a wireless or wired transmitter and receiver, respectively, operable for interfacing with external devices.

Additionally, device 600 may include a data store 608, which can be any suitable combination of hardware and/or software, that provides for mass storage of information, databases, and programs employed in connection with aspects described herein. For example, data store 608 may be or may include a data repository for operating systems (or components thereof), applications, related parameters, etc. not currently being executed by processor 602.

Device 600 may optionally include a user interface component 610 operable to receive inputs from a user of device 600 and further operable to generate outputs for presentation to the user. User interface component 610 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 610 may include one or more output devices, including but not limited to a display, a speaker, a haptic feedback mechanism, a printer, any other mechanism capable of presenting an output to a user, or any combination thereof.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A device for providing access to an on-premises resource executing via a cloud-computing environment, comprising:
one or more memories storing instructions; and
one or more processors coupled to the one or more memories and configured to execute the instructions to:
receive, by a client-side proxy executing on a centralized node in the cloud-computing environment and from a client resource provider (RP) that communicates with the client-side proxy via a client RP virtual network established in the cloud-computing environment, a request by a requesting node to access the on-premises resource; and
provide, by the client-side proxy and based on the request, access to the on-premises resource for the requesting node.

2. The device of claim 1, wherein the one or more processors are configured to execute the instructions to provide, to the client RP, a hostname or internet protocol (IP) address associated with the centralized node executing the client-side proxy, and an indication of a client-side proxy virtual network associated with the client-side proxy.

3. The device of claim 2, wherein the one or more processors are configured to execute the instructions to peer the client RP virtual network with the client-side proxy virtual network based on a request received from the client RP.

4. The device of claim 2, wherein the one or more processors are configured to execute the instructions to receive, from the client RP, a list of regions to which the client RP is providing the on-premises resource, wherein the one or more processors are configured to execute the instructions to provide, to the client RP, the hostname or IP address at least in part by providing, to the client RP and based on the list of regions, a list of hostnames or IP addresses associated with multiple centralized nodes executing the client-side proxy.

5. The device of claim 2, wherein the hostname or IP address associated with the centralized node includes a hostname or IP address of a load balancer or ingress controller associated with the centralized node.

6. The device of claim 1, wherein the one or more processors are configured to execute the instructions to provide, to the client RP, a domain name or an internet protocol (IP) address associated with one or more centralized nodes, including the centralized node, executing the client-side proxy.

7. The device of claim 6, wherein the one or more processors are configured to execute the instructions to provide the domain name or the IP address based on managing a domain name service (DNS) zone that resolves a hostname associated with the centralized node to the domain name or the IP address.

8. The device of claim 6, wherein the domain name or the IP address associated with the one or more centralized nodes includes a hostname or IP address of one or more load balancers or ingress controllers associated with the one or more centralized nodes.

9. A device for providing access to an on-premises resource executing via a cloud-computing environment, comprising:
one or more memories storing instructions; and
one or more processors coupled to the one or more memories and configured to execute the instructions to:
receive, for a client-side proxy executing on a centralized node in a cloud-computing environment, and via a client resource provider (RP) virtual network established in the cloud-computing environment, a request by a requesting node to access the on-premises resource; and
provide, to the client-side proxy, the request from the requesting node to facilitate access to the on-premises resource for the requesting node.

10. The device of claim 9, wherein the one or more processors are configured to execute the instructions to receive, from an onboarding node of the cloud-computing environment, a hostname or internet protocol (IP) address associated with the centralized node executing the client-side proxy, and an indication of a client-side proxy virtual network associated with the client-side proxy.

11. The device of claim 10, wherein the one or more processors are configured to execute the instructions to request peering of the client RP virtual network with the client-side proxy virtual network based on receiving the indication of the client-side proxy virtual network.

12. The device of claim 10, wherein the one or more processors are configured to execute the instructions to provide, to the onboarding node, a list of regions to which the on-premises resource is provided, wherein the one or more processors are configured to execute the instructions to receive the hostname or IP address at least in part by receiving, from the onboarding node and based on the list of regions, a list of hostnames or IP addresses associated with multiple centralized nodes executing the client-side proxy.

13. The device of claim 10, wherein the one or more processors are configured to execute the instructions to request creating of a private domain name service (DNS) zone in the client RP virtual network to resolve a hostname of the client-side proxy to an internet protocol (IP) address associated with the centralized node.

14. The device of claim 13, wherein the IP address associated with the centralized node includes an IP address of a load balancer or ingress controller associated with the centralized node.

15. The device of claim 9, wherein the one or more processors are configured to execute the instructions to receive, from the cloud-computing environment, a domain name or an internet protocol (IP) address associated with one or more centralized nodes, including the centralized node, executing the client-side proxy.

16. The device of claim 15, wherein the domain name or the IP address associated with the one or more centralized nodes includes a hostname or IP address of one or more load balancers or ingress controllers associated with the one or more centralized nodes.

17. A computer-implemented method for providing access to an on-premises resource executing via a cloud-computing environment, comprising:
receiving, by a client-side proxy executing on a centralized node in the cloud-computing environment and from a client resource provider (RP) that communicates with the client-side proxy via a client RP virtual network established in the cloud-computing environment, a request by a requesting node to access the on-premises resource; and
providing, by the client-side proxy and based on the request, access to the on-premises resource for the requesting node.

18. The computer-implemented method of claim 17, further comprising providing, to the client RP, a hostname or internet protocol (IP) address associated with the centralized node executing the client-side proxy, and an indication of a client-side proxy virtual network associated with the client-side proxy.

19. The computer-implemented method of claim 18, further comprising peering the client RP virtual network with the client-side proxy virtual network based on a request received from the on-premises RP.

20. The computer-implemented method of claim 17, further comprising providing, to the client RP, a domain name or an internet protocol (IP) address associated with one or more centralized nodes, including the centralized node, executing the client-side proxy.
